(19) United States
(12) Patent Application Publication
(10) Pub. No.: US 2016/0068553 A1
(43) Pub. Date: Mar. 10, 2016

(54) NOVEL COMPOUND AND RESIN COMPOSITION CONTAINING THE SAME

(71) Applicant: CANON KABUSHIKI KAISHA, Tokyo (JP)

(72) Inventors: Katsuhiro Matsuda, Kawasaki-shi (JP); Toshinari Miura, Kawasaki-shi (JP); Takeshi Komuro, Matsudo-shi (JP)

(21) Appl. No.: 14/784,644

(22) PCT Filed: Apr. 14, 2014
(86) PCT No.: PCT/JP2014/002094

§ 371 Date: Oct. 15, 2015

(30) Foreign Application Priority Data
Apr. 17, 2013 (JP) 2013-086628
Mar. 27, 2014 (JP) 2014-067099

(51) Int. Cl. C08K 5/52; C07F 9/02; B29B 7/00; G03G 15/00

(52) U.S. Cl. CPC C07F 9/12; C08L 69/005; C08L 25/12; C08L 9/06; C08L 27/18; G03G 21/1619

(57) ABSTRACT

To provide a compound which can demonstrate flame retardancy equal to or higher than V-1 of the UL94 standard by adding a flame retardant to resin containing aromatic polyester and styrene polymer.

To provide a compound represented by General Formula (1) of Claim 1.

In General Formula (1), R₁ to R₃ are alkyl groups having 1 to 4 carbon atoms and R₁ to R₃ may be the same or different from each other.

### TECHNICAL FIELD

The present invention relates to a compound which imparts flame retardancy to resin containing aromatic polyester and a styrene polymer and to a resin composition containing the same.

### BACKGROUND ART

Heretofore, resin for use in electrical and electric parts is imparted with flame retardancy by a flame retardant in accordance with the intended use and the portion for which the resin is used. As the flame retardant, bromine flame retardants, phosphorus flame retardants, inorganic flame retardants, silicone flame retardants, and the like are known. For example, a phosphorus flame retardant is kneaded with resin containing aromatic polyester and a styrene polymer (PC+ABS or PC+AS) which has been frequently used for copying machines, and the resin is imparted with the flame retardancy of V-2 to 5VB of the UL94 standard relating to the flame retardancy of resin materials in accordance with the intended use.

On the other hand, a biomass-derived resin containing plants as the raw materials has drawn attention from the viewpoint of a reduction in petroleum resources. For example, polylactic acid containing starch, such as corn starch, as the raw materials is mentioned. With respect to the biomass-derived resin, the strength and the flame retardancy are improved by forming an alloy with a petroleum-derived resin or using an additive, and then the biomass-derived resin is practically used for housings of copying machines and the like.

However, the flame retardants contain resources such as petroleum resources and minerals, exhaustion of which is concerned. Thus, the development of a flame retardant utilizing renewable resources, such as plants, has been demanded from the viewpoint of environmental protection.

Among the flame retardants which impart flame retardancy to resin, tannin described in PTL 1, potassium hydrogen tartrate described in PTL 2, and a phosphorus containing polymer composite salt containing phytic acid described in PTL 3 are known as substances synthesized using plants as the raw materials.

The flame retardants described in PTL 1 to PTL 3 develop high flame retardancy. However, when the flame retardants described in PTL 1 to PTL 3 are applied to a thermoplastic resin containing aromatic polyester and a styrene polymer, such as PC+ABS (alloy resin of polycarbonate and acrylonitrile butadiene styrene) which is frequently used for OA apparatuses, such as a copying machine, it is difficult for the flame retardants to pass a vertical burning test of the UL94 standard.

Even when the tannin, the potassium hydrogen tartrate, and the phosphorus containing polymer composite salt containing phytic acid which are substances synthesized from plants and are known as substances that impart flame retardancy to resin are added to PC+ABS, the flame retardancy equal to or higher than V-1 of the UL94 standard cannot be imparted thereto. This is considered to originate from the fact that these compounds are hydrophilic, and therefore the compatibility with resin is low.

### CITATION LIST

### Patent Literature

PTL 1: Japanese Patent Laid-Open No. 2006-077215
PTL 2: Japanese Patent Laid-Open No. 2002-348575
PTL 3: Japanese Patent Laid-Open No. 2002-348575

### SUMMARY OF INVENTION

The present invention provides a compound capable of imparting high flame retardancy even when the flame retardant is added to resin containing aromatic polyester and a styrene polymer.

Therefore, the present invention provides a compound represented by the following General Formula (1).

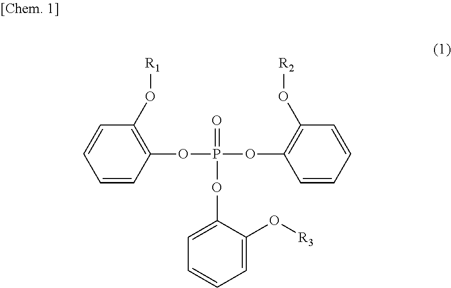

In General Formula (1), R₁ to R₃ are alkyl groups having 1 to 4 carbon atoms. R₁ to R₃ may be the same or different from each other.

Further features of the present invention will become apparent from the following description of exemplary embodiments.

### BRIEF DESCRIPTION OF DRAWINGS

FIG. 1A is an outside view of an example of an image formation apparatus according to this embodiment.

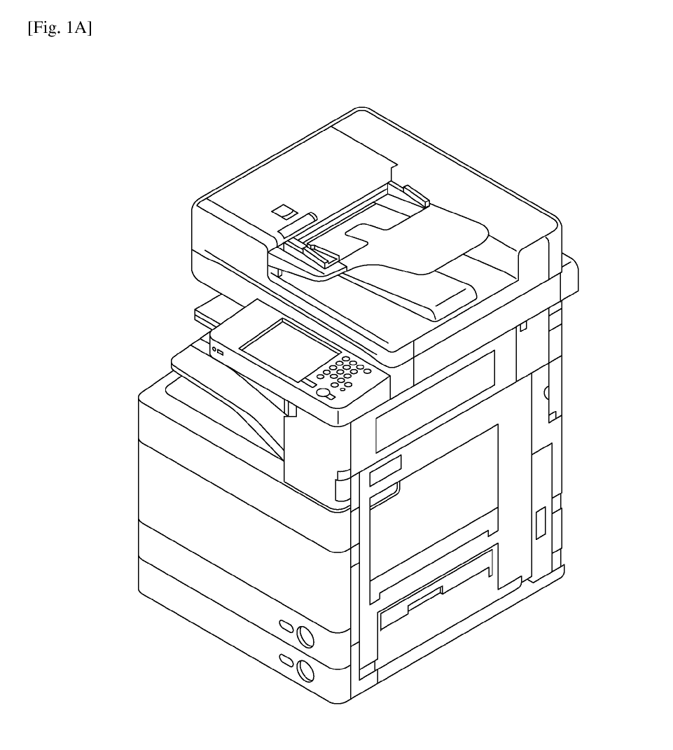

FIG. 1B is a schematic view of an example of the image formation apparatus according to this embodiment.

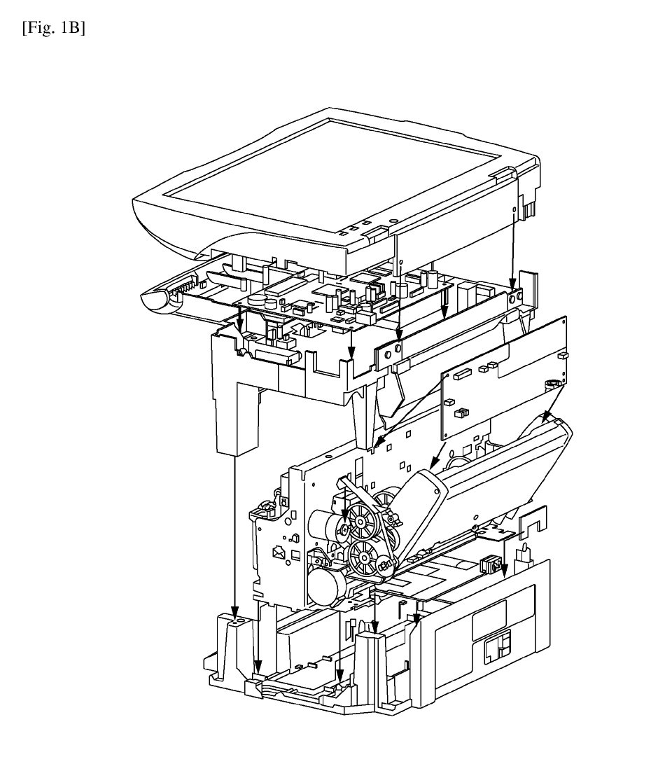

### DESCRIPTION OF EMBODIMENT

The present invention is a compound represented by the following General Formula (1). In this embodiment, the compound shown below is also referred to as a flame retardant compound and is also referred to as an A component as a component of a resin composition.

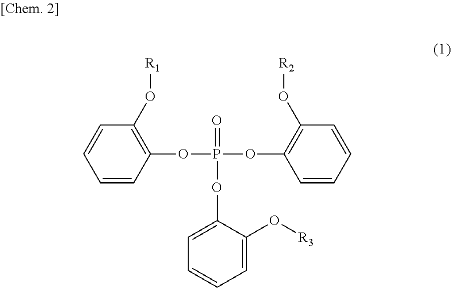

In General Formula (1), R₁ to R₃ are alkyl groups having 1 to 4 carbon atoms. R₁ to R₃ may be the same or different from each other. With respect to the alkyl group, the alkyl group is preferably methyl group.

The compound according to the invention has high flame retardancy and does not have a hydroxyl group and has an alkyl group in the structure, and therefore the compound according to the invention is lipophilic. Therefore, the compound is likely to dissolve in resin containing aromatic polyester and a styrene polymer. Therefore, even when the compound is added to the resin, the compound can develop high flame retardancy.

On the other hand, the tannin is hydrophilic because the tannin has a hydroxy group which is hydrophilic in the structure and the potassium hydrogen tartrate and the phosphorus containing polymer composite salt containing phytic acid are salts and therefore they are hydrophilic and the compatibility thereof with resin is low. As a result, when the tannin is added to resin, high flame retardancy cannot be demonstrated.

The compound according to the invention can demonstrate high flame retardancy even when the compound is added to the resin containing aromatic polyester and a styrene polymer.

The compound according to the invention can be manufactured by a method described below, for example.

The compound according to the invention can be obtained by esterifying guaiacol synthesized from plants and phosphorus oxychloride in the presence of a base or a catalyst as shown in the following Reaction Formula (2).

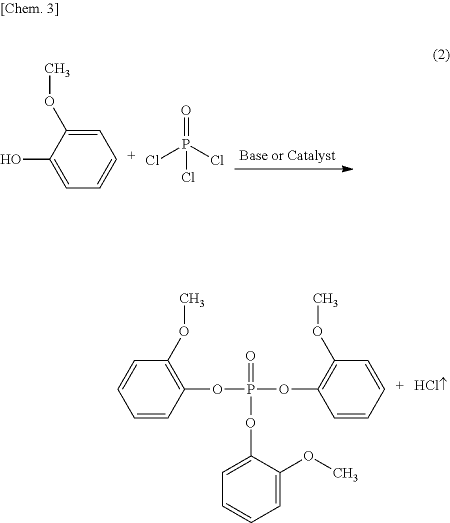

A method for manufacturing a compound represented by the following Structural Formula (1) is described above as an example. By selecting a substituent and a start substance as appropriate, the flame retardant according to the invention can be manufactured.

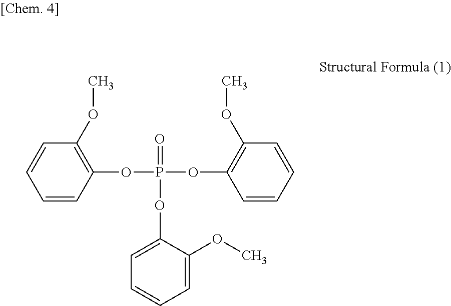 [SMILES: COc1ccccc1OP(=O)(Oc1ccccc1OC)Oc1ccccc1OC]

Moreover, in order to advance the esterification in Formula (2), a base or a catalyst can be made to coexist. The base traps hydrogen chloride to be by-produced to form a hydrochloric acid salt of the base which is made to coexist. Therefore, there is an effect in which the equilibrium of the esterification can be shifted to the reaction product side, so that the reaction speed is increased to improve the yield.

As such a base, tertiary amines, such as triethylamine and pyridine, and alkali metal hydroxides are suitable. On the other hand, when primary amines or secondary amines are used, amide phosphate is generated in addition to phosphate ester, and therefore the yield is low. Moreover, the reaction can also be advanced by making Lewis acid, such as magnesium chloride, coexist, and then heating.

The reaction mixture obtained by the reaction can be purified by a known isolation method. The purification is suitable because the remaining amount of an unreacted substance, a catalyst, and the like becomes small. When the remaining amount of the unreacted substance, the catalyst, and the like is large, the flame retardancy decreases and, when kneading resin, the resin is deteriorated, which may be a cause of reducing the physical properties. The isolation method includes filtration, washing, drying, and the like.

The melting point, measured by a differential scanning calorimetry (DSC), of the compound (A component) of the invention obtained by the above-described method and represented by General Formula (1) is 99 degrees (Celsius) and the 5% weight reduction temperature measured by a thermogravimetry (TGA) is 249 degrees (Celsius). These values show that the compound has a heat characteristic which allows the flame retardant to sufficiently stand the kneading with the resin containing aromatic polyester and a styrene polymer and the like.

Guaiacol for use in the compound according to the invention is suitably synthesized from plants from the viewpoint of a reduction in the consumption of the petroleum resources. The guaiacol synthesized from plants can be obtained by a known method, such as distilling pyroligneous acid generated when charcoal is manufactured from beech or the like. It is a matter of course that guaiacol obtained by chemical synthesis may be used.

A flame retardant according to this embodiment comprises the compound in the invention. Hereinafter, a resin composition according to this embodiment is described.

The resin composition comprises the flame retardant and resin. The resin is exemplified as thermoplastic resin, thermosetting resin. The resin composition according to this embodiment is a resin composition containing aromatic polyester, a styrene polymer, a dripping inhibitor, and the compound according to the invention, in which the content of the aromatic polyester is 40 wt % or more and 90 wt % or less when the total weight of the resin composition is 100 wt %, the content of the styrene polymer is 5 wt % or more and 30 wt % or less when the total weight of the resin composition is 100 wt %, the content of the dripping inhibitor is 0.1 wt % or more and 1.0 wt % or less when the total weight of the resin composition is 100 wt %, and the content of the compound is 10 wt % or more and 25 wt % or less when the total weight of the resin composition is 100 wt %. The addition of the weight percent (wt %) of each substance above gives 100 wt % or less.

The aromatic polyester (B component) contained in the resin composition according to this embodiment is not particularly limited and is suitably polycarbonate.

The styrene polymer (C component) contained in the resin composition according to this embodiment includes a compound containing styrene as a monomer and a compound containing a styrene derivative as a monomer. These compounds can contain phenylethylene in the structure. Specifically, an acrylonitrile-butadiene-styrene copolymer, an acrylonitrile-styrene copolymer, and the like are mentioned. These copolymers can also be referred to as a compound containing acrylonitrile, butadiene, and styrene and a compound containing acrylonitrile and styrene, respectively.

The B component and the C component are suitably PC+ABS containing aromatic polyester and an acrylonitrile-butadiene-styrene copolymer or PC+AS containing aromatic polyester and an acrylonitrile-styrene copolymer.

PC+ABS is a mixture of PC (polycarbonate) and ABS (acrylonitrile-butadiene-styrene copolymer). The mixing manner thereof is not particularly limited and it is suitable that PC and ABS are mixed to form an alloy resin.

The weight of the aromatic polyester (B component) contained in the resin composition of this embodiment is suitably 40 wt % or more and 90 wt % or less when the total weight of the resin composition is 100 wt %. This is because when the weight is less than 40 wt %, the strength of the resin composition becomes weak and when the weight exceeds 90 wt %, the molding temperature becomes high, which may be a cause of defective coloration of a molded article.

The weight of the styrene polymer (C component) contained in the resin composition of this embodiment is suitably 5 wt % or more and 30 wt % or less when the total weight of the resin composition is 100 wt %. When the weight is less than 5 wt %, the molding temperature becomes high, which may be a cause of defective coloration of a molded article. On the other hand, when the weight exceeds 30 wt %, the flame retardancy of the resin composition cannot be achieved. Specifically, in a burning test according to the UL94 standard, the burning time is prolonged and the flame retardancy equal to or higher than V-1 of the UL94 standard cannot be secured.

The weight of the compound (A component) contained in the resin composition of this embodiment is suitably 10 wt % or more and 25 wt % or less when the total weight of the resin composition is 100 wt %. This is because when the weight is less than 10 wt %, the flame retardant effect becomes low and when the weight exceeds 25 wt %, the strength becomes low.

The type of the dripping inhibitor (D component) contained in the resin composition according to this embodiment is not particularly limited and polytetrafluoroethylene (hereinafter referred to as PTFE), PTFE modified with another resin, or a PTFE containing mixture is suitable due to good handling properties and dispersibility. Specifically, Metablen A-3800 (trade name, manufactured by Mitsubishi Rayon Co. Ltd.) which is an acrylic resin modified PTFE is mentioned.

The content of the dripping inhibitor (D component) contained in the resin composition of this embodiment is suitably 0.1 wt % or more and 1 wt % or less when the total weight of the resin composition is 100 wt %. In the case where the weight is less than 0.1 wt %, when a burning test piece is ignited, the resin is likely to melt and drip from the test piece. Therefore, the flame retardancy equal to or higher than V-1 of the UL94 standard is hard to obtain.

When the influence on the environment is taken into consideration, the weight of the PTFE contained in the composition is suitably less than 0.5 wt % when the total weight of the flame retardant resin composition of this embodiment is 100 wt %.

For example, in the case of Metablen A-3800, since the PTFE is contained in a proportion of 50 wt % based on 100 parts by weight, it is suitable to add A-3800 in a proportion of less than 1.0 wt % when the total weight of the resin composition is 100 wt %.

With respect to the weight percent of the resin composition according to this embodiment, the charge amount ratio can also be regarded to be the composition ratio of the composition. Moreover, the composition ratio of the composition can also be measured by measuring the NMR. When the composition ratio of the resin composition of the molded article is analyzed, the analysis can be performed by crushing the molded article, extracting the resin composition with a good solvent, and then analyzing the same by an analysis method, such as NMR. The good solvent includes DMF (dimethyl formamide), DMSO (dimethyl sulfoxide), and THF (tetrahydrofuran).

To the resin composition of this embodiment, a butadiene rubber or pigment, a heat stabilizer, an antioxidant, an inorganic filler, a plant fiber, a weather resistant agent, a lubricant, a mold release agent, an antistatic agent, and the like can be added insofar as the properties of the resin composition are not considerably impaired.

The butadiene rubber includes ABS, MBS, and the like. The form of the butadiene rubber is not particularly limited and may be a block polymer, a random polymer, and a core shell type.

The resin contained in the resin composition according to this embodiment may be a recovered resin. When using the recovered resin, the resin composition can be referred to as a recycled resin. When manufacturing the recycled resin, the flame retardant according to the invention may be added to a prepared resin.

The resin to be recovered includes resin used for housings of image forming apparatuses, resin used for camera parts, resin used for housings and internal parts of personal computers, resin used for housings and internal parts of televisions, and resin used for water bottles.

The molded article according to this embodiment can be obtained by molding a prepared composition containing the flame retardant according to the invention. For the molding, known techniques, such as extrusion molding and ejection molding, can be used.

The molded article of this embodiment can be used for internal parts of copying machines, internal parts of laser beam printers, housings and internal parts of ink jet printers, toner cartridge parts of copying machines and laser beam printers, housings and internal parts of facsimiles, camera parts, housings and internal parts of personal computers, housings and internal parts of televisions, and the like.

The molded article according to this embodiment can be used for parts that require flame retardancy in image forming apparatuses, such as copying machines, laser beam printers, and ink jet printers. Specifically, housings for accommodating photoconductors, members around fixing units, members around power supplies, and the like are mentioned.

Moreover, the molded article according to this embodiment can be used as outer housings insofar as the design is not affected.

### EXAMPLES

Hereinafter, Examples of the invention are described. The technical scope of the invention is not limited thereto. The measurement and the evaluation were performed using the following methods and devices.

(1) Flame Retardancy

Test method: V test (20 mm vertical burning test) and HB test (Horizontal burning test) according to the UL94 standard

The HB test was performed only for those which did not pass the V test.

Sample shape: Test piece for flame retardant test (125 mm×12.5 mm×t2 mm)

(2) Melting Point (Tm) Measurement

Device name: Differential scanning calorimetry manufactured by TA Instruments

Pan: Aluminum pan

Sample weight: 3 mg

Temperature elevation starting temperature: 30 degrees (Celsius)

Temperature elevation rate: 10 degrees (Celsius)/min

Atmosphere: Nitrogen

(3) Thermal Decomposition Temperature (Td) Measurement*¹ *1 Temperature at which 5% weight reduction was observed was defined as Td.

Device name: Thermogravimetry manufactured by TA Instruments

Pan: Platinum pan

Sample weight: 3 mg

Temperature elevation starting temperature: 30 degrees (Celsius)

Measurement mode: Dynamic rate method*² *2 Measurement mode in which the heating rate is controlled in accordance with the degree of weight changes, and the resolution improves.

Atmosphere: Nitrogen

### Manufacturing Example 1

### Synthesis of Compound Represented by Structural Formula (1)

Guaiacol (470.8 g, 3.72 mol) dehydrated with MgSO₄ and phosphorus oxychloride (190.0 g, 1.23 mol) were weighed out into a 3-L separable flask, and then stirred with a mechanical starter under nitrogen.

To the mixture, 1.5 L of THF (Moisture amount of 20 ppm or less) was added. Furthermore, triethylamine (486.6 g, 4.78 mol) was added thereto from a dropping funnel over 1.5 hours. The reaction was performed at an internal temperature of 60 degrees (Celsius) for 18 hours. The obtained reaction mixture was neutralized in an aqueous NaOH solution, and then the hydrochloride of the triethylamine was removed by filtration to obtain a light yellow filtrate.

A reaction mixture obtained by condensing the filtrate by an evaporator was developed in 5 L of water, and then a white crystalline substance was obtained. The white crystalline substance was stirred and washed twice in 5 L of water with a mechanical stirrer over 12 hours, filtered, and then vacuum-dried at 70 degrees (Celsius) for 48 hours, whereby the flame retardant (A component) was obtained with 93% yield.

The melting point (Tm) of the flame retardant (A component) measured with a differential scanning calorimetry (DSC) thus obtained was 99 degrees (Celsius) and the 5% weight reduction temperature (Td) thereof measured with a thermogravimetry (TGA) was 249 degrees (Celsius). The results clarified that the flame retardant had a heat characteristic which allows the flame retardant to sufficiently stand the heat when kneaded with resin.

Moreover, the structure was identified by ¹H-NMR, it was clarified that this product was a compound represented by Structural Formula (1) considering the fact that the peak of the protons of the hydroxy group of the guaiacol disappeared and the integration values (a) of the protons derived from the benzene ring of guaiacol of delta=7.40 ppm, 7.42 ppm, delta=7.11 ppm, 7.13 ppm, and delta=6.87 ppm, 6.87, 6.89, 6.92, 6.94 and the integration values (b) of the protons of a methoxy group of guaiacol of delta=3.76 ppm, 3.79 ppm established (a):(b)=4:3.

### Manufacturing Example 2

### Synthesis of Phosphorus Containing Polymer Composite Salt

A phosphorus containing polymer composite salt was synthesized as described below with reference to Example 9 in PTL 3.

Phytic acid (50 wt % aqueous solution, Purity of 50.4%) of 400 g (301.2 mmol) was weighed out, and then 36.57 g (602.4 mmol) of 28 wt % ammonia water was slowly added thereto with attention to bumping due to heat of neutralization.

3-(2-aminoethylamino)propyl trimethoxysilane of 140.99 g (602.4 mmol) was added to 4.5 L of methanol.

An aqueous phytic acid-ammonia water solution was slowly added while stirring the mixed liquid of methanol and aminosilane. Immediately after the addition, a white deposit was generated. The white deposit was stirred for 24 hours. After stirring, the deposit was separated by filtration. The deposit was dried at 110 degrees (Celsius) for 24 hours with a vacuum dryer. After vacuum drying, the deposit was crushed, and put through a 1-mm mesh sieve, and then used for kneading with resin. The yield was 92%.

### Examples 1 to 6, Comparative Examples 1 to 10

The PC+ABS used in Examples and Comparative Examples was dried with hot air at 80 degrees (Celsius) for 6 hours or more in a pellet state as described in each Example.

In Examples 1 to 6, the materials shown in Table 1 were weighed out in such a manner as to have a mass ratio shown in Table 1, and then mixed. Thereafter, the mixture was melt and kneaded at a cylinder temperature of 220 degrees (Celsius) to 240 degrees (Celsius) with a biaxial extruder (Laboplastomill, trade name, manufactured by Toyo Seiki Seisakusho Co., Ltd.).

Thereafter, the resin discharged from the extruder top end was cut into a pellet shape to obtain pellets of the resin. The obtained pellets were dried with hot air at 80 degrees (Celsius) for 6 hours, and then molded into a test piece for flame retardant test (125 mm×12.5 mm×t2 mm) at a cylinder temperature of 200 degrees (Celsius) to 220 degrees (Celsius) and at a mold temperature of 40 degrees (Celsius) using an injection molding machine (SE18DU, trade name, manufactured by Sumitomo Heavy Industries, Ltd.).

In Comparative Example 1 and Comparative Example 2, the PC+ABS (1) and the PC+ABS (2) shown below were dried with hot air at 80 degrees (Celsius) for 6 hours without kneading, and then molded into a test piece for flame retardant test (125 mm×12.5 mm×t2 mm) at a cylinder temperature of 235 degrees (Celsius) to 250 degrees (Celsius) and at a mold temperature of 40 degrees (Celsius) using an injection molding machine (SE18DU, trade name, manufactured by Sumitomo Heavy Industries, Ltd.).

In Comparative Examples 3 to 10, substances were weighed out so as to have a mass ratio shown in Table 2, and then kneaded at a cylinder temperature of 200 degrees (Celsius) to 220 degrees (Celsius) such that a degree of heat deterioration of the flame retardant was small. The obtained pellets were dried with hot air at 80 degrees (Celsius) for 6 hours, and then molded into a test piece for flame retardant test (125 mm×12.5 mm×t2 mm) at a cylinder temperature of 200 degrees (Celsius) to 220 degrees (Celsius) and at a mold temperature of 40 degrees (Celsius) using an injection molding machine (SE18DU, trade name, manufactured by Sumitomo Heavy Industries, Ltd.).

However, in Comparative Example 3 and Comparative Example 5, since the fluidity was low, the cylinder temperature of the injection molding machine was set to 220 degrees (Celsius) to 235 degrees (Celsius), and then test pieces for flame retardant test were molded.

The following materials were used as materials shown in Table 1 and 2.

PC+ABS(1) “Cycoloy C1110” trade name, manufactured by SABIC, weight ratio of PC and ABS of 7:3

PC+ABS(2) “Cycoloy C1200HF” trade name, manufactured by SABIC, weight ratio of PC and ABS of 8:2

Flame retardant (A component): one described in Manufacturing Example 1

Tannic acid: manufactured by Kishida Chemical Co., Ltd.

Sodium laurate: manufactured by Kishida Chemical Co., Ltd.

Sucrose: manufactured by Kishida Chemical Co., Ltd.

Potassium hydrogen tartrate: manufactured by Kishida Chemical Co., Ltd.

Phytin: “Phytin (extract)” manufactured by Tsuno rice fine chemicals Co., Ltd.

Phosphorus containing polymer composite salt: one described in Manufacturing

### Example 2

Fluorine compound: “Metablen A-3800” trade name, manufactured by Mitsubishi Rayon Co., Ltd.

Processing stabilizer: “IRGANOX B220” trade name, manufactured by BASF

Butadiene rubber: “Metablen C223A” trade name, manufactured by Mitsubishi Rayon Co., Ltd.

The compounding ratio and the flame retardancy measurement (V test) results of Examples 1 to 6 are shown in Table 1. The compounding ratio and the flame retardancy measurement (V test and HB test) results of Comparative Examples 1 to 10 are shown in Table 2. Moreover, the judging criteria of the V test (20 mm vertical burning test) of the UL94 standard are shown in Table 3.

TABLE 1

| | | Exam- | Exam- | Exam- | Exam- | Exam- | Exam- |
|---|---|---|---|---|---|---|---|
| | | ple | ple | ple | ple | ple | ple |
| | | 1 | 2 | 3 | 4 | 5 | 6 |
| Resin | PC + | 76.8 | — | — | — | — | — |
| (wt %) | ABS(1) | | | | | | |
| | PC + | — | 86.8 | 83.8 | 80.8 | 76.8 | 80.8 |
| | ABS(2) | | | | | | |
| Flame | Flame | 22 | 12 | 15 | 18 | 22 | 15 |
| retar- | retar- | | | | | | |
| dant | dant | | | | | | |
| (wt %) | (A) | | | | | | |
| Fluorine | A-3800 | 1 | 1 | 1 | 1 | 1 | 1 |
| com- | | | | | | | |
| pound | | | | | | | |
| (wt %) | | | | | | | |
| Anti- | IRGA- | 0.2 | 0.2 | 0.2 | 0.2 | 0.2 | 0.2 |
| oxidant | NOX | | | | | | |
| (wt %) | B220 | | | | | | |
| Buta- | Meta- | — | — | — | — | — | 3 |
| diene | blen | | | | | | |
| rubber | C223A | | | | | | |
| Exper- | V test | V-1 | V-0 | V-0 | V-0 | V-0 | V-0 |
| iment | (2.0 | | | | | | |
| results | mm | | | | | | |
| | thick- | | | | | | |
| | ness) | | | | | | |

TABLE 2

| | | Compar- | Compar- | Compar- | Compar- | Compar- | Compar- | Compar- | Compar- | Compar- | Compar- |
|---|---|---|---|---|---|---|---|---|---|---|---|
| | | ative | ative | ative | ative | ative | ative | ative | ative | ative | ative |
| | | Example | Example | Example | Example | Example | Example | Example | Example | Example | Example |
| | | 1 | 2 | 3 | 4 | 5 | 6 | 7 | 8 | 9 | 10 |
| Resin | PC + ABS(1) | 100 | — | 98.3 | 88.8 | 78.8 | 78.8 | 738 | — | — | — |
| (wt %) | PC + ABS(2) | — | 100 | — | — | — | — | — | 78.8 | 73.8 | 89.8 |
| Flame | Tannin | — | — | 0.14 | — | — | — | — | — | — | — |
| retardant, | Sodium borate | — | — | 0.07 | — | — | — | — | — | — | — |
| (wt %) | Sucrose | — | — | 0.29 | — | — | — | — | — | — | — |
| | Potassium | — | — | — | 10 | — | — | — | — | — | — |
| | tartrate | | | | | | | | | | |
| | Phytin | — | .— | — | — | 20 | — | — | — | — | — |
| | Phosphorus | — | — | — | — | — | 20 | 25 | 20 | 25 | — |
| | containing | | | | | | | | | | |
| | polymer | | | | | | | | | | |
| | composite salt | | | | | | | | | | |
| | Flame | — | — | — | — | — | — | — | — | — | 9 |
| | retardant (A) | | | | | | | | | | |
| Fluorine | A-3800 | — | — | 1 | 1 | 1 | 1 | 1 | 1 | 1 | 1 |
| compound | | | | | | | | | | | |
| (wt %) | | | | | | | | | | | |
| Antioxidant | IRGANOX | — | — | 0.2 | 0.2 | 0.2 | 0.2 | 0.2 | 0.2 | 0.2 | 0.2 |
| (wt%) | B220 | | | | | | | | | | |
| Butadiene | Metablen | — | — | — | — | — | — | — | — | — | — |
| rubber | C223A | | | | | | | | | | |
| Experiment | V test (2.0 mm | Not- | Not- | Not- | Not- | Not- | Not- | Not- | Not- | Not- | Not- |
| results | thickness) | pass | pass | pass | pass | pass | pass | pass | pass | pass | pass |
| | HB test | 38.1 | 38.1 | 39.1 | 64.5 | 33.6 | 0 | 0 | 0 | 0 | 0 |
| | (2.0 mm | | | | | | | | | | |
| | thickness) | | | | | | | | | | |
| | Burning rate | | | | | | | | | | |
| | mm/min | | | | | | | | | | |

TABLE 3

| | V-0 | V-1 | V-2 |
|---|---|---|---|
| Burning time after moving | 10 seconds | 30 seconds | 30 seconds |
| flame away from each sample | or less | or less | or less |
| at first or second time | | | |
| Total burning time after | 50 seconds | 250 seconds | 250 seconds |
| moving flame away ten times | or less | or less | or less |
| Total of burning time after | 30 seconds | 60 seconds | 60 seconds |
| moving flame away at second | or less | or less | or less |
| time and glowing time | | | |
| Ignition of absorbent cotton | Not- | Not- | Occurred |
| due to drips | occurred | occurred | |

As is understood from Table 2, Comparative Examples 1 to 10 did not pass the V test. It was clarified that when the combination of tannin, sodium laurate, and sucrose was kneaded with PC+ABS, the burning rate in the horizontal burning test was higher than that of the PC+ABS simple substance, and the flame retardancy decreased.

Moreover, it was also clarified that when hydrogen sodium tartrate was kneaded with PC+ABS, the burning rate increased than that of the PC+ABS simple substance, and the flame retardancy decreased.

The phytin and the phosphorus containing polymer composite salt lowered the burning rate in the horizontal burning test than the PC+ABS simple substance but did not pass the V test.

On the other hand, it is found that when the flame retardant (A component) of the invention was used, the flame retardant has flame retardancy equal to or higher than V-1 as shown in Table 1 and the flame retardancy is higher than that of the flame retardant synthesized from other plants. Then, as is understood from Comparative Example 10 of Table 2, in the case of 9 wt % of the flame retardant (A component), Comparative Example 10 did not pass the V test.

The resin composition of the invention can obtain flame retardancy equal to or higher than V-1 of the UL94 standard and can be used for a portion requiring flame retardancy, such as internal parts of copying machines.

The invention can provide a flame retardant which has high compatibility with resin and can impart flame retardancy equal to or higher than V-1 of the UL94 standard.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-086628, filed Apr. 17, 2013, and Japanese Patent Application No. 2014-067099, filed Mar. 27, 2014, which are hereby incorporated by reference herein in their entirety.

1. A compound, which is represented by a following General Formula (1), 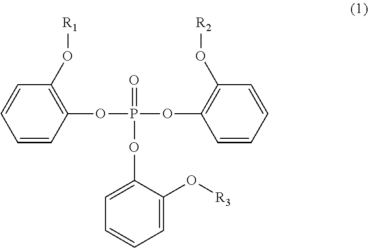
wherein
in General Formula (1), R₁ to R₃ are alkyl groups having 1 to 4 carbon atoms and R₁ to R₃ may be the same or different from each other.

2. The compound according to claim 1, which is represented by a following Structural Formula.

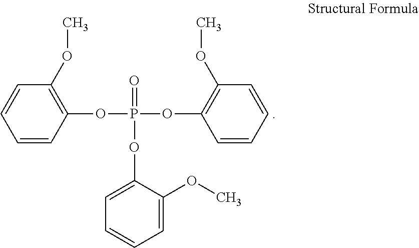 [SMILES: COc1ccccc1OP(=O)(Oc1ccccc1OC)Oc1ccccc1OC]

3. The compound according to claim 2, wherein the compound is plant derived.

4. A flame retardant comprising the compound according to claim 1.

5. A resin composition comprising resin and the flame retardant according to claim 4.

6. A resin composition containing aromatic polyester, a styrene polymer, a dripping inhibitor, and the flame retardant according to claim 4, wherein
a content of the aromatic polyester is 40 wt % or more and 90 wt % or less when a total weight of the resin composition is 100 wt %,
a content of the styrene polymer is 5 wt % or more and 30 wt % or less when the total weight of the resin composition is 100 wt %,
a content of the dripping inhibitor is 0.1 wt % or more and 1.0 wt % or less when the total weight of the resin composition is 100 wt %, and
a content of the flame retardant is 10 wt % or more and 25 wt % or less when the total weight of the flame retardant composition is 100 wt %.

7. The resin composition according to claim 6, wherein the aromatic polyester is aromatic polycarbonate.

8. The resin composition according to claim 6, wherein the styrene polymer is an acrylonitrile-butadiene-styrene copolymer or an acrylonitrile-styrene copolymer.

9. The resin composition according to claim 6, wherein the dripping inhibitor is a compound containing polytetrafluoroethylene.

10. A molded article, which is obtained by molding the resin composition according to claim 6.

11. The molded article according to claim 10, wherein the aromatic polyester and the styrene polymer are obtained from recovered resin.

12. The molded article according to claim 10, wherein flame retardancy is equal to or higher than V-1 in a V test of UL94 standard.

13. An image forming apparatus, comprising:
a photoconductor; and
a housing for accommodating the photoconductor, wherein
the housing is the molded article according to claim 10.

14. A resin composition comprising resin and a flame retardant, wherein the frame retardant is the compound according to claim 3.

15. A resin composition containing aromatic polyester, a styrene polymer, a dripping inhibitor, and a flame retardant; the frame retardant is the compound according to claim 3, wherein
a content of the aromatic polyester is 40 wt % or more and 90 wt % or less when a total weight of the resin composition is 100 wt %,
a content of the styrene polymer is 5 wt % or more and 30 wt % or less when the total weight of the resin composition is 100 wt %,
a content of the dripping inhibitor is 0.1 wt % or more and 1.0 wt % or less when the total weight of the resin composition is 100 wt %, and
a content of the flame retardant is 10 wt % or more and 25 wt % or less when the total weight of the flame retardant composition is 100 wt %.

16. A method for manufacturing a resin composition containing aromatic polyester, a styrene polymer, a fluorine compound, and a flame retardant represented by a following General Formula (1), the method comprising:
mixing the aromatic polyester with a weight of 40% by weight or more and 90% by weight or less, the styrene polymer with a weight of 5% by weight or more and 30% by weight or less, the dripping inhibitor with a weight of 0.1% by weight or more and 1.0% by weight or less, and the flame retardant with a weight of 10% by weight or more and 25% by weight or less based on 100% by weight of the total weight of the resin composition; and then
heating the aromatic polyester, the styrene polymer, the dripping inhibitor, and the flame retardant. 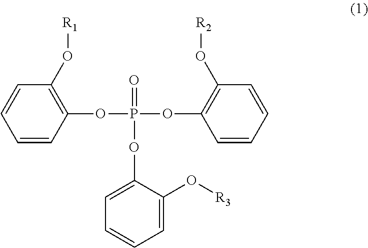
wherein
in General Formula (1), R₁ to R₃ are alkyl groups having 1 to 4 carbon atoms and R₁ to R₃ may be the same or different from each other.

17. A method for manufacturing a molded article containing a flame retardant composition, the method comprising:
preparing a flame retardant composition, and
molding the flame retardant composition, wherein
the flame retardant composition is obtained by the method for manufacturing a flame retardant composition according to claim 16.

18. The method for manufacturing a molded article according to claim 17, wherein the molding of the flame retardant composition is extrusion molding or injection molding.
